(19) United States
(12) Patent Application Publication
(10) Pub. No.: US 2007/0106667 A1
(43) Pub. Date: May 10, 2007

(54) Generalized deadlock resolution in databases

(75) Inventors: Kamal Jain, Bellevue, WA (US); Kunal Talwar, San Francisco, CA (US); Mohammadtaghi Hajiaghayi, Cambridge, MA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/271,130

(22) Filed: Nov. 10, 2005

(51) Int. Cl. G06F 17/30

(52) U.S. Cl. 707/8

(57) ABSTRACT

AND/OR graphs representative of database transactions are leveraged to facilitate in providing transaction deadlock resolutions with a guarantee in performance. In one instance, predominantly OR-based transaction deadlocks are resolved via killing a minimum cost set of graph nodes to release associated resources. This process can be performed cyclically to resolve additional deadlocks. This allows a minimal impact approach to resolving deadlocks without requiring wholesale cancellation of all transactions and restarting of entire systems. In another instance, a model is provided that facilitates in resolving deadlocks permanently. In an AND-based transaction case, a bipartite mixed graph is employed to provide a graph representative of adversarially schedulable transactions that can acquire resource locks in any order without deadlocking.

### BACKGROUND

Transaction processing systems have led the way for many ideas in distributed computing and fault-tolerant computing. For example, transaction processing systems have introduced distributed data for reliability, availability, and performance, and fault tolerant storage and processes, in addition to contributing to a client-server model and remote procedure call for distributed computation. More importantly, transaction processing introduced the concept of transaction ACID properties—atomicity, consistency, isolation and durability that has emerged as a unifying concept for distributed computations. Atomicity refers to a transaction's change to a state of an overall system happening all at once or not at all. Consistency refers to a transaction being a correct transformation of the system state and essentially means that the transaction is a correct program. Although transactions execute concurrently, isolation ensures that transactions appear to execute before or after another transaction because intermediate states of transactions are not visible to other transactions (e.g., locked during execution). Durability refers to once a transaction completes successfully (commits) its activities or its changes to the state become permanent and survive failures.

Many applications are internal to a business or organization. With the advent of networked computers and modems, computer systems at remote locations can now easily communicate with one another. This allows computer system applications to be used between remote facilities within a company. Applications can also be of particular utility in processing business transactions between different companies. Automating such processes can result in significant improvements in efficiency, not otherwise possible. However, this inter-company application of technology requires co-operation of the companies and proper interfacing of the individual company's existing computer systems.

In conventional business workflow systems, a transaction comprises a sequence of operations that change recoverable resources and data from one consistent state into another, and if a deadlock occurs (i.e., multiple actions requiring access to the same resource) before the transaction reaches normal termination, the transactions are canceled to allow the system to restart. This can be extremely costly, both in time and resources, to a business because all transactions are halted after the deadlock, regardless of their costs. Thus, even if only a single deadlock occurs, the entire system or systems are restarted.

### SUMMARY

The following presents a simplified summary of the subject matter in order to provide a basic understanding of some aspects of subject matter embodiments. This summary is not an extensive overview of the subject matter. It is not intended to identify key/critical elements of the embodiments or to delineate the scope of the subject matter. Its sole purpose is to present some concepts of the subject matter in a simplified form as a prelude to the more detailed description that is presented later.

The subject matter relates generally to databases, and more particularly to systems and methods for resolving deadlocks in database transactions. AND/OR graphs are leveraged to facilitate in providing a deadlock resolvable solution with a guarantee in performance. In one instance, predominantly OR-based transaction deadlocks are resolved via killing a minimum cost set of graph nodes to release associated resources. This process can be performed cyclically to resolve additional deadlocks. This allows a minimal impact approach to resolving deadlocks without requiring wholesale cancellation of all transactions and restarting of entire systems. In another instance, a model is provided that facilitates in resolving deadlocks permanently. In AND-based transactions, a bipartite mixed graph can be employed to provide a graph representative of adversarially schedulable transactions that can acquire resource locks in any order without deadlocking. This also provides a performance guarantee for the special case. Thus, these instances provide higher performing systems with minimal or no impact due to deadlocking of transaction resources, reducing downtime, costs, and computing resource utilization.

To the accomplishment of the foregoing and related ends, certain illustrative aspects of embodiments are described herein in connection with the following description and the annexed drawings. These aspects are indicative, however, of but a few of the various ways in which the principles of the subject matter may be employed, and the subject matter is intended to include all such aspects and their equivalents. Other advantages and novel features of the subject matter may become apparent from the following detailed description when considered in conjunction with the drawings.

### BRIEF DESCRIPTION OF THE DRAWINGS

FIG. 1 is a block diagram of a deadlock resolution system in accordance with an aspect of an embodiment.

FIG. 2 is another block diagram of a deadlock resolution system in accordance with an aspect of an embodiment.

FIG. 3 is yet another block diagram of a deadlock resolution system in accordance with an aspect of an embodiment.

FIG. 4 is a block diagram of a permanent deadlock resolution system in accordance with an aspect of an embodiment.

FIG. 5 is a flow diagram of a method of facilitating deadlock resolutions in accordance with an aspect of an embodiment.

FIG. 6 is a flow diagram of a method of facilitating permanent deadlock resolutions in accordance with an aspect of an embodiment.

FIG. 7 is another flow diagram of a method of facilitating permanent deadlock resolutions in accordance with an aspect of an embodiment.

FIG. 8 illustrates an example operating environment in which an embodiment can function.

FIG. 9 illustrates another example operating environment in which an embodiment can function.

### DETAILED DESCRIPTION

The subject matter is now described with reference to the drawings, wherein like reference numerals are used to refer to like elements throughout. In the following description, for purposes of explanation, numerous specific details are set forth in order to provide a thorough understanding of the subject matter. It may be evident, however, that subject matter embodiments may be practiced without these specific details. In other instances, well-known structures and devices are shown in block diagram form in order to facilitate describing the embodiments.

As used in this application, the term “component” is intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a computer component. One or more components may reside within a process and/or thread of execution and a component may be localized on one computer and/or distributed between two or more computers.

Systems and methods are provided that facilitate in resolving deadlocks for database transactions. The resolution techniques also provide a performance guarantee. Deadlocks happen in databases and need to be resolved as economically as possible. There are classical models for encapsulating the deadlock resolution problems, but, in general, these problems are very hard and no algorithm with guaranteed performance is available. In one instance, a technique with guaranteed performance for frequent “read” transactions is provided that resolves the general deadlock resolution problem in databases.

Generally, deadlock resolution is a temporary property, whereas deadlock itself is a permanent property. This means that if a deadlock occurs it must be resolved before additional transactions can be processed. Deadlocks do not go away on their own accord. Even after a deadlock is resolved, another deadlock can occur soon afterward. A model is thus provided herein in which reoccurrence of a deadlock can be captured (which is an even harder problem to solve). However, other instances herein employing mixed graphs provide a process to solve the deadlock resolution problem permanently (unless some new transactions are introduced) with guaranteed performance.

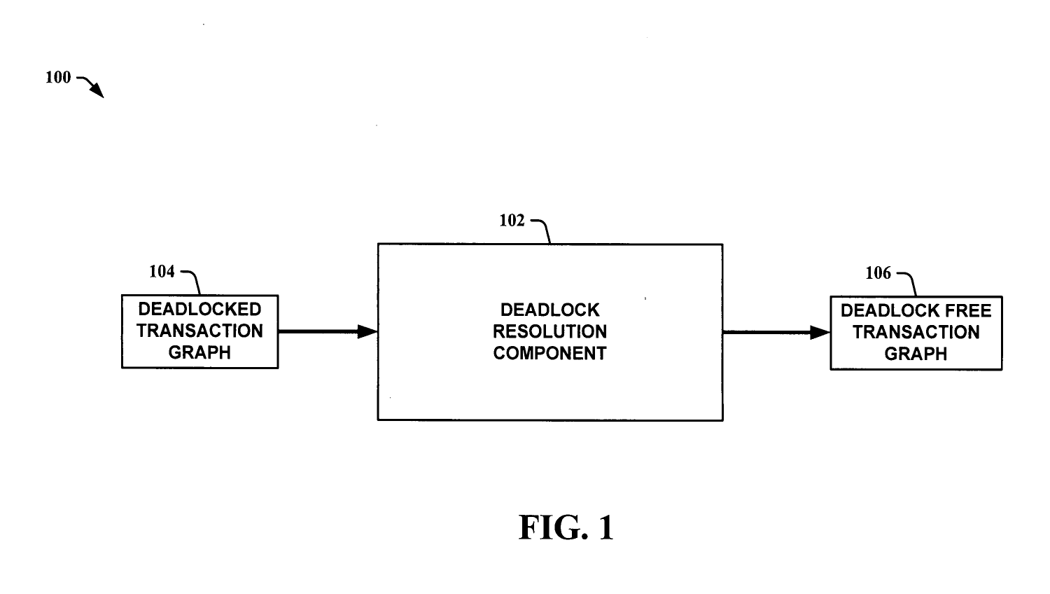

In FIG. 1, a block diagram of a deadlock resolution system 100 in accordance with an aspect of an embodiment is shown. The deadlock resolution system 100 is comprised of a deadlock resolution component 102 that obtains a deadlocked transaction graph 104 and provides a deadlock free transaction graph 106. The deadlocked transaction graph 104 is substantially comprised of OR-based transactions with few or no AND-based transactions. OR-based transactions are representative of read transactions while AND-based transactions are representative of write transactions. The deadlock resolution component 102 resolves the deadlocks in the deadlocked transaction graph 104 via removal (i.e., killing) of nodes of the deadlocked transaction graph 104 that have the least amount of impact (i.e., minimum cost or “weight”). It 102 accomplishes this with a guaranteed performance. The deadlock resolution component 102 employs a process that kills a set of AND/OR nodes such that the remaining graph is deadlock free and the weight (i.e., cost) of the solution is at most (1+lnΔₒᵤₜ)nₐ+1=O(nₐ log n) times optimum (discussed in detail infra). This allows the deadlock resolution system 100 to substantially outperform traditional systems that require a total restart to resolve deadlocks.

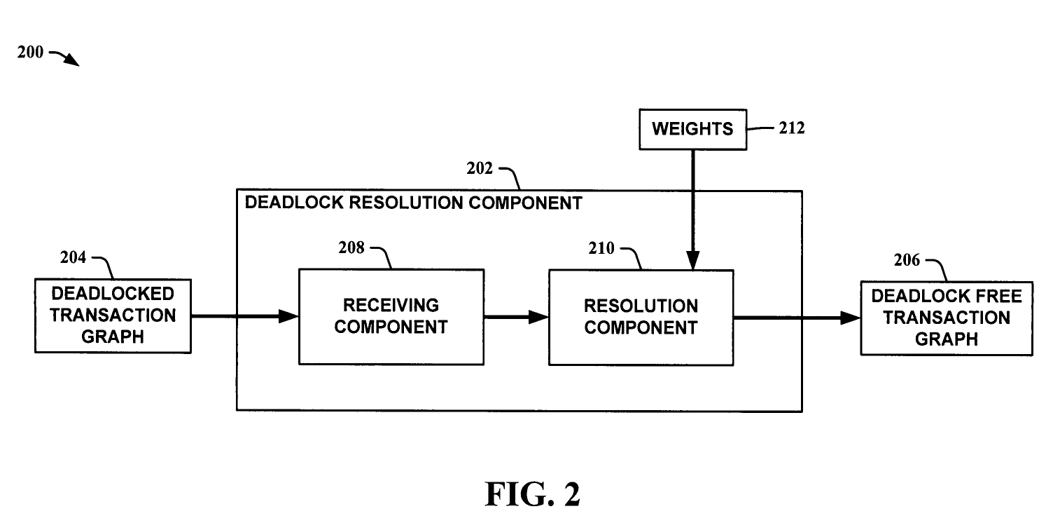

Looking at FIG. 2, another block diagram of a deadlock resolution system 200 in accordance with an aspect of an embodiment is depicted. The deadlock resolution system 200 is comprised of a deadlock resolution component 202 that obtains a deadlocked transaction graph 204 and provides a deadlock free transaction graph 206. The deadlock resolution component 202 is comprised of a receiving component 208 and a resolution component 210. The deadlocked transaction graph 204 is substantially comprised of OR-based transactions with few or no AND-based transactions. The receiving component 208 obtains the deadlocked transaction graph 204 and performs pre-processing when necessary. The resolution component 210 receives the deadlocked transaction graph 204 from the receiving component 208 and resolves deadlocks in the deadlocked transaction graph 204 by employing weights 212 to facilitate in determining a minimum cost deadlock resolution solution. The weights 212 are assigned to the nodes of the deadlocked transaction graph 204 and are utilized to determine the minimum cost deadlock resolution solution. Processes employed by the resolution component 210 to resolve deadlocks are discussed in detail infra. As stated previously, performance of the solution is guaranteed.

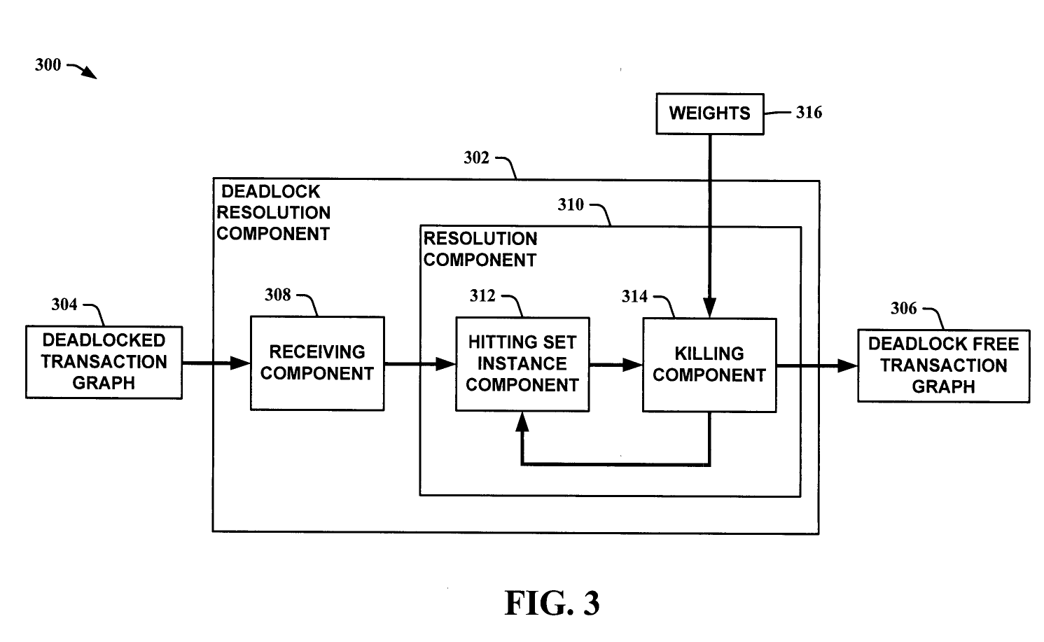

Turning to FIG. 3, yet another block diagram of a deadlock resolution system 300 in accordance with an aspect of an embodiment is illustrated. The deadlock resolution system 300 is comprised of a deadlock resolution component 302 that obtains a deadlocked transaction graph 304 and provides a deadlock free transaction graph 306. The deadlock resolution component 302 is comprised of a receiving component 308 and a resolution component 310. The resolution component 310 is comprised of a hitting set instance component 312 and a killing component 314. The deadlocked transaction graph 304 is substantially comprised of OR-based transactions with few or no AND-based transactions. The receiving component 308 obtains the deadlocked transaction graph 304 and performs pre-processing when necessary.

The hitting set instance component 312 receives the deadlocked transaction graph 304 from the receiving component 308 and constructs a hitting set instance for the deadlocked transaction graph 304. For example, for each AND node a whose outgoing edges are (a,c₁),(a c₂), . . . , (a,c_{Δ}_{ₒᵤₜ}) in the deadlocked transaction graph 304 and all cᵢ's, 1≦i≦Δₒᵤₜ, are OR nodes, a hitting set instance is constructed by the hitting set instance component 312 as follows. For each cᵢ, 1≦i≦Δₒᵤₜ, a set Sᵢ is formed which contains all OR nodes reachable via OR nodes from cᵢ. Thus, a collection C contains all sets Sᵢ⊂S, where S is the set of all OR nodes.

The killing component 314 receives the deadlocked transaction graph 304 from the hitting set instance component 312 and employs an approximation for the hitting set provided by the hitting set instance component 312. By utilizing a (1+lnΔₒᵤₜ)=O(log n) approximation for the hitting set and weights 316, a set S*ₐ of weight w*ₐ of OR nodes which hit every set is obtained. Let Wₐ=min{wₐ,w*ₐ}(wₐ is the weight of node a). The killing component 314 selects an AND node a with a minimum Wₐ over all AND nodes of the deadlocked transaction graph 304. The killing component 314 then kills AND node a or the OR nodes in the corresponding hitting set solution. The killing component 314 clears deadlocked transaction graph 304 (i.e., removes every AND/OR node which can be completed after killing the appropriate nodes). The killing component 314 can then output the modified graph as the deadlock free transaction graph 306 and/or it can cycle the modified graph back to the hitting set instance component 312 and re-process the modified graph until a resolution is obtained. The deadlock free transaction graph 306 excludes all AND/OR nodes killed during the iterations. As an optional output (not shown in FIG. 3), the killing component 314 can provide all AND/OR nodes killed during the iterations, along with or in place of, the deadlock free transaction graph 306. The above processes are discussed in more detail infra.

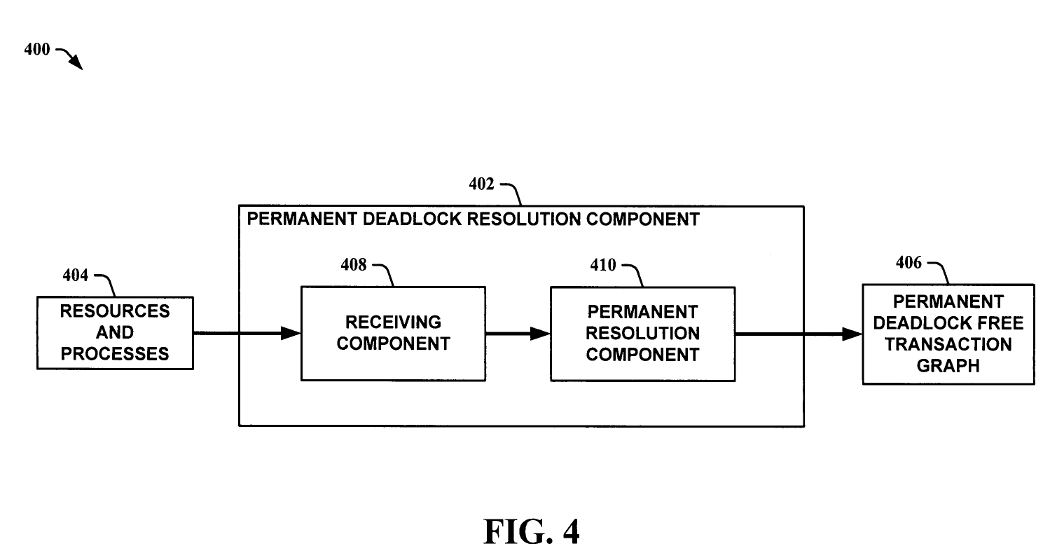

Moving on to FIG. 4, a block diagram of a permanent deadlock resolution system 400 in accordance with an aspect of an embodiment is shown. The deadlock resolution system 400 is comprised of a permanent deadlock resolution component 402 that obtains resources and processes 404 and provides a permanent deadlock free transaction graph 406. The permanent deadlock resolution component 402 is comprised of a receiving component 408 and a permanent resolution component 410. The receiving component 408 obtains resources and processes 404 that are associated with AND-based database transactions and provides pre-processing when necessary. The resources and processes 404 are typically associated with transactions that are not able to be scheduled in a feasible manner to prevent deadlocks. Thus, the permanent resolution component 410 receives the resources and processes 404 from the receiving component 408 and kills enough such that if the remaining processes try to acquire locks in any order, they cannot deadlock. Thus, the remaining processes are adversarially schedulable. When all processes are AND-based transactions, an O(log n loglog n)-approximation can be employed. For example, the permanent resolution component 410 can construct a bipartite mixed graph for a given set of resources R and a set of processes P (i.e., resources and processes 404), each holding a lock on some subset of resources, and waiting to get locks on another subset of resources. The permanent resolution component 410 constructs the graph by creating a vertex vᵣ for every resource r with infinite cost, and a vertex vₚ for every process p. Whenever process p holds the lock on resource r, the permanent resolution component 410 adds a directed edge from vₚ to vᵣ and, whenever process p is waiting to get a lock on resource r′, adds an undirected edge between vₚ and v_{r′} to create the permanent deadlock free transaction graph 406.

The systems and methods herein utilize approximation techniques associated with the AND/OR directed feedback vertex set problem to provide deadlock resolution. The AND/OR feedback vertex set problem results from a practical deadlock resolution problem that appears in the development of distributed database systems. This problem is also a natural generalization of the directed feedback vertex set problem. Awerbuch and Micali (see, B. Awerbuch and S. Micali, Dynamic deadlock resolution protocols, in The 27th Annual Symposium on Foundations of Computer Science, 1986, pp. 196-207) presented a polynomial time algorithm to find a minimal solution for this problem. Unfortunately, a minimal solution can be arbitrarily more expensive than the minimum cost solution. Finding the minimum cost solution is as hard as the directed Steiner tree problem (and thus Ω(log² n) hard to approximate). Instances of the systems and methods herein, however, provide techniques that work well when the number of writers (AND nodes) is small. Other instances also provide a permanent deadlock resolution where an execution order for the surviving processes cannot be specified, allowing scheduling even if the processes are adversarial. Instances of the systems and methods herein can employ an O(log n loglog n) approximation for this problem when all processes are writers (AND nodes).

One of the best ways to understand deadlocks in databases is the dining philosophers' problem. There are five philosophers sitting on a circular table to preparing to eat spaghetti, with a fork between every two of them. Each philosopher needs two forks to eat. But everyone grabs the fork on the right, hence everyone has one fork and waiting for another to be freed. This wait will be never ending unless one of the philosophers gave up and freed up their fork. This never ending is an example of a deadlock. Picking up a philosopher who can give up on eating the spaghetti is an example of deadlock resolution. Now suppose that these philosophers have different likings for the spaghetti and hence different inherent cost of giving up eating it. In this case, it is desirable to select the philosopher who likes spaghetti the least. This is called the minimum cost deadlock resolution problem.

In databases, philosophers correspond to independent agents e.g., transactions and processes. Forks correspond to shared resources, e.g., shared memory. Eating spaghetti corresponds to actions which these independent agents want to perform on the shared resources e.g., reading or writing a memory location. So in general besides asking for two forks these philosophers may ask for two spoons too, while they have grabbed only one each. These spoons and forks can be of different kinds (e.g., plastic or metal). In general, demands for resources can be very complicated, and it can be represented by a monotonic binary function, called demand function. A demand function takes a vector of resources as an input and outputs whether it can satisfy the demand or not.

When a process does not get all the resources to satisfy its demand then it has to wait. Like any other protocol involving waiting, there is a risk of deadlock. There are ways to avoid deadlock, like putting a total order on all the resources and telling the users to ask them in the same order. In big or distributed databases, such solutions are difficult to implement. Moreover such a solution works when the demand functions consist of only ANDs. In essence, deadlocks do happen and they need to be resolved at a small cost. In practice one of the convenient solutions is to time out on wait, i.e., if it takes too long for a transaction to acquire further resources then it aborts and frees up the resources held so far. This solution does not have any guarantee on the cost incurred. For notational convenience, aborting a transaction is also referred to as killing it. An associated cost of killing a process (this cost can also be the cost of restarting it) is assumed. The cost of a solution is the total cost of all the processes killed. For the minimum cost deadlock resolution problem, it is desirable to kill the least expensive set of processes to resolve the deadlock.

An instance of a generalized deadlock detection problem is captured by a waits-for-graph (WFG) on transactions. A survey by Knapp (see, E. Knapp, Deadlock detection in distributed databases, ACM Computing Surveys (CSUR), 19 (1987), pp. 303-328) mentions many relevant models of WFG graphs. In the AND model, formally defined by Chandy and Misra (see, K. M. Chandy and J. Misra, A distributed algorithm for detecting resource deadlocks in distributed systems, in Proceedings of the first ACM SIGACT-SIGOPS symposium on Principles of distributed computing, ACM Press, 1982, pp. 157-164), transactions are permitted to request a set of resources. A transaction is blocked until it gets all the resources it has requested.

In the OR model, formally defined by Chandy et al. (see, K. M. Chandy, J. Misra, and L. M. Haas, Distributed deadlock detection, ACM Transactions on Computer Systems (TOCS), 1 (1983), pp. 144-156), a request for numerous resources are satisfied by granting any requested resource, such as satisfying a read request for a replicated data item by reading any copy of it. In a more generalized AND-OR model, defined by Gray et al. (see, J. Gray, P. Homan, R. Obermarck, and H. Korth, A straw man analysis of probability of waiting and deadlock, in Proceedings of the fifth International Conference on Distributed Data Management and Computer Networks, 1981) and Herman et al. (see, T. Herman and K. M. Chandy, A distributed procedure to detect and/or deadlock, Tech. Rep. TR LCS-8301, Dept. of Computer Sciences, Univ. of Texas, 1983), requests of both kinds are permitted.

A node making an AND request is called an AND node and a node making an OR request is called an OR node. An advantage of using both these kinds of nodes is that one can express (this expression can be of exponential size—see Knapp 1987 for more models of waits-for-graphs) arbitrary demand functions e.g., if a philosopher wants any one fork and any one spoon then two sub-agents for this philosopher can be created, one responsible for getting a fork and the other for getting a spoon. This philosopher then becomes an AND node and the two sub-agents become two OR nodes. From the perspective of algorithm design, detecting deadlocks in all these models is not a difficult task (see, e.g., M. Flatebo and A. K. Datta, Self-stabilizing deadlock detection algorithms, in Proceedings of the 1992 ACM annual conference on Communications, ACM Press, 1992, pp. 117-122; K. Makki and N. Pissinou, Detection and resolution of deadlocks in distributed database systems, in Proceedings of the fourth international conference on Information and knowledge management, ACM Press, 1995, pp. 411-416; and H. Wu, W. N. Chin, and J. Jaffar, An efficient distributed deadlock avoidance algorithm for the and model, IEEE Transactions on Software Engineering, 28 (2002), pp. 18-29).

The difficult task is to resolve it once detected and that too at a minimum cost (for some heuristics and surveys on the generalized AND-OR model (see, e.g. Awerbuch and Micali 1986; G. Bracha and S. Toueg, A distributed algorithm for generalized deadlock detection, in Proceedings of the third annual ACM symposium on Principles of distributed computing, ACM Press, 1984, pp. 285-301; K. M. Chandy and L. Lamport, Distributed snapshots: determining global states of distributed systems, ACM Transactions on Computer Systems (TOCS), 3 (1985), pp. 63-75; J. M. Helary, C. Jard, N. Plouzeau, and M. Raynal, Detection of stable properties in distributed applications, in Proceedings of the sixth annual ACM Symposium on Principles of distributed computing, ACM Press, 1987, pp. 125-136; and C. S. Shih and J. A. Stankovic, Distributed deadlock detection in ada run-time environments, in Proceedings of the conference on TRI-ADA '90, ACM Press, 1990, pp. 362-375). Instances of the systems and method herein utilize model the problem as an AND/OR directed feedback vertex set problem.

Often it may not be possible for the deadlock resolving algorithm to specify a schedule for the remaining processes, and when the cost of calling the deadlock resolution algorithm is large (as one would expect in a distributed setting), it is desirable that, no matter in what order the surviving transactions are scheduled, they do not deadlock again. For the case when the transactions are all writers (the AND only case), instances of the system and methods herein provide a polynomial-time approximation technique for the problem.

When all the nodes are OR nodes then the problem can be solved in polynomial time via strongly connected components decomposition. But the problem quickly becomes at least as hard as the set-cover problem even in the presence of a single AND node. The reductions utilized herein have deadlock cycles of length 3 capturing the special case mentioned by Jim Gray (in practice deadlocks happen because of cycles of length 2 or 3). Instances of the systems and methods herein provide an O(nₐ log(n_{O})) factor approximation algorithm, where n_{O} is the number of OR nodes and nₐ is the number of AND nodes. On the other hand, if all the nodes are AND nodes, the problem is the well-studied directed feedback vertex set problem. There are approximation algorithms with polylog approximation factor for this problem due to Leighton-Rao (see, T. Leighton and S. Rao, Multicommodity max-flow min-cut theorems and their use in designing approximation algorithms, J. ACM, 46 (1999), pp. 787-832) and Seymour (see, P. D. Seymour, Packing directed circuits fractionally, Combinatorica, 15 (1995), pp. 281-288).

From the hardness point of view, the problem is as hard as the directed Steiner tree problem, which was shown to be hard to approximate better than a factor of O(log^{2-ε}n) by Halperin and Krauthgamer (see, E. Halperin and R. Krauthgamer, Polylogarithmic in approximability, in The 35th Annual ACM Symposium on Theory of Computing (STOC'03), 2003, pp. 585-594), and has no known polynomial time polylogarithmic approximation algorithm. One difficulty in designing an approximation algorithm for the problem is that good LP relaxation techniques are not known. The natural LP relaxation itself is at least as hard as the directed Steiner tree problem, even for the case of one OR node. It is interesting to consider algorithms provided herein in terms of LP rounding. This is done in case there is one (or a constant number of) OR nodes. The size of this LP is exponential in the number of OR nodes.

For the permanent deadlock resolution problem, it is shown herein that the case with only AND nodes is reducible to the feedback vertex set problem in mixed graphs. Acyclicity implies schedulability for both undirected and directed graphs—acyclic undirected graphs have leaves and acyclic directed graphs have sinks. A corresponding theorem for bipartite mixed graphs is also provided herein. This leads to an O(log n loglog n) approximation algorithm for this problem.

This problem was also studied in theoretical computer science by Awerbuch and Micali (see, Awerbuch and Micali 1986). In their publication, they mention that the ideal goal is to kill a set of processes with minimum cost, but the problem is a generalization of feedback vertex set and seems very hard. Thus, they gave a distributed algorithm for finding a minimal solution. Unfortunately, a minimal solution can be arbitrarily more expensive than the minimum cost solution. The techniques herein leverage approximation algorithms to provide deadlock resolution. This problem blends naturally with feedback vertex and arc set problems. From a hardness point of view, it blends naturally with the directed Steiner tree and set cover problems.

The graphs mentioned herein are directed without loops or multiple edges, unless stated otherwise. See standard references for appropriate background information (see, J. A. Bondy and U. S. R. Murty, Graph Theory with Applications, American Elsevier Publishing Co., Inc., New York, 1976 and D. B. West, Introduction to Graph Theory, Prentice Hall Inc., Upper Saddle River, N.J., 1996). In addition, for exact definitions of various undefined NP-hard graph-theoretic problems, refer to Garey and Johnson (see, M. R. Garey and D. S. Johnson, Computers and Intractability: A Guide to the Theory of NP-completeness, W. H. Freeman and Co., San Francisco, Calif., 1979).

The graph terminology utilized herein is as follows. A graph G is represented by G=(V, E), where V (or V(G)) is the set of vertices (or nodes) and E (or E(G)) is the set of edges. An edge e from u to v is denoted by (u,v), and it is called an outgoing edge for u and an incoming edge for v. Node u can reach node v (or equivalently v is reachable from u) if there is a path from u to v in the graph. The notation uv is utilized to denote that v is reachable from u. n is defined to be the number of vertices of a graph when this is clear from context. The maximum out-degree is denoted by Δₒᵤₜ and the maximum in-degree is denoted by Δᵢₙ. The node set V is assumed to be partitioned into two sets Vₐ and V_{O}. Nodes in Vₐ and V_{O} are referred to as AND nodes and OR nodes respectively. Let nₐ=|Vₐ| and n_{O}=|V_{O}|. With this terminology, the wait-for-graphs (WFG) can be defined.

Each node of a wait-for-graph, G=(V, E), represents a transaction. An edge (u,v) denotes that transaction u has made a request for a resource currently held by transaction v. There are two kinds of nodes. An AND node represents a transaction which has made an AND request on a set of resources, which are held by other transactions. An OR node represents a transaction which has made an OR request on a set of resources. Without loss of generality, it is assumed that a transaction is allowed to make only one request. If a transaction makes multiple requests then a sub-transaction can be created for each request and the necessary dependency edges can be added. Each transaction has an associated weight. The weight of a transaction u is denoted by wᵤ.

An AND transaction can be scheduled if it gets all the resources it has requested. An OR transaction can be scheduled if it gets at least one of the resources it has requested. Once a transaction is scheduled, it gives up all its locks, potentially allowing other processes to get scheduled. A wait-for-graph is called deadlock free if there exists an ordering of the transactions in which they can be executed successfully. If no such ordering exists then the graph has a deadlock. The minimum cost generalized deadlock resolution problem (GDR) is to kill the minimum weight set of transactions to free up the resources held by them so that the remaining transactions are deadlock free. In other words, there exists an order on the remaining transactions such that for each AND transaction, each of its children is either killed or can be completed before it and, for each OR transaction, at least one of its children is either killed or can be completed before it.

Special Cases

The following are propositions which illustrate points about the minimum GDR problem.
Proposition 1: The GDR problem when there is no OR node has an approximation algorithm with ratio O(log n loglog n).
Proposition 2: The GDR problem with all OR nodes can be solved in polynomial time.
   In fact, Proposition 2 can be strengthened as follows:
Proposition 3: The GDR problem, when the reachability graph on the AND nodes is a directed acyclic graph, can be solved in polynomial time.
Proposition 4: The GDR problem with uniform weights and O(log n) AND nodes can be solved in polynomial time.
Proposition 5: The GDR problem with uniform weights and nₐ AND nodes has an O(nₐ)-approximation algorithm.
   Hardness and Natural LP

A simple approximation preserving reduction from the set cover problem to this problem is illustrated. Recall that the set cover problem is to find a minimum collection C of sets from a family F⊂2^{U}, such that C covers U, i.e. ∪_{S∈C}S=U. From the results of Lund and Yannakakis (see, C. Lund and M. Yannakakis, On the hardness of approximating minimization problems, J. Assoc. Comput. Mach., 41 (1994), pp. 960-981) and Feige (see, U. Feige, A threshold of In n for approximating set cover, J. ACM, 45 (1998), pp. 634-652), it follows that no polynomial time algorithm approximates the set cover problem better than a factor of In n unless NP⊂DTIME(n^{loglog n}). The reduction then implies a similar hardness for the GDR problem. There is no similar in approximability result known for the directed feedback vertex set problem.
Theorem 6: There exists an approximation preserving reduction from (unweighted) set cover to GDR with only one AND node.
Proof: Consider an instance of set cover problem with a collection C={S₁, . . . , Sₘ} of subsets of S={e₁, . . . , eₙ}. For each element eᵢ (subset Sᵢ), an OR node eᵢ(Sᵢ) is created. In addition, one AND node a is created. The set of directed edges E is as follows: the AND node a has edges to all the element nodes. An element node e has edges to all set nodes corresponding to sets containing it. Finally, all set nodes have edges to the AND node a.

Formally,
E(G)={(a,eᵢ)|1≦i≦n}∪{(Sⱼ,a)|1≦j≦m}∪{(eᵢ,Sⱼ)|eᵢ∈Sⱼ}.
The weight of the AND node is ∞(or a very large number M depending on the instance size) and the weight of all other nodes is one. It is easy to see that any set cover solution gives a solution to this GDR instance. The sets in the cover are killed. Since they cover all elements, all nodes corresponding to the elements can be completed. Then the AND node is completed and, finally, all other non-killed nodes which correspond to non-selected sets are completed.

Moreover, any solution to this GDR instance gives a solution to the original set cover instance. The AND node cannot be killed and, instead of killing a node eᵢ, it is better (or at least as good) to kill a node Sⱼ where eᵢ∈Sⱼ. Thus, any solution can be converted to one of no larger cost where only sets are killed, and, hence, leads to a set cover. In the reduction of Theorem 6, there is only one AND node whose weight is m+1 and the rest of the vertices are OR nodes with weight one. Moreover, the one AND node of high weight can be replaced by m+1 AND nodes of unit weight placed “in parallel.” Thus, the uniform weight case is also hard to approximate better than a factor of Ω(log n).

Now, the question is that whether it is possible to get a better in approximability result. To answer this question, a result of Halperin and Krauthgamer (see, Halperin and Krauthgamer 2003) is utilized on the in approximability of the directed Steiner tree problem. In the directed Steiner tree problem, given a directed graph G=(V, E), a root r∈V and a set of terminals T∈V, the goal is to find a minimum subset E′⊂E such that in graph G′=(V, E′) there is a path from r to every t∈T. Halperin and Krauthgamer (see, Halperin and Krauthgamer 2003) show that the directed Steiner tree problem is hard to approximate better than a factor of Ω(log² n), unless NP⊂ZTIME(n^{polylog n}). No polynomial-time polylogarithmic approximation algorithm is known for this problem. A similar non-approximability result is shown in Theorem 7 below for GDR by giving an approximation preserving reduction from directed Steiner tree.
Theorem 7: There exists an approximation preserving reduction from directed Steiner tree to GDR.
Proof: Consider an instance of directed Steiner tree given by a directed graph G=(V, E), a set of terminals T⊂V and a root node r∈V. The goal is to find a minimum cost subset E′ of edges containing a path from r to every terminal t∈T. The reduction is as follows. For each vertex v∈V−{r}, an OR node v of weight ∞ (as usual, the ∞ weights can be replaced by a (polynomially) large weight) is created in our GDR instance. For r, an OR node r of weight zero is created. In addition, an AND node a of weight ∞ which has an edge (a,t) for each t∈T and an edge (v,a) for each v∈V exists. For each edge e∈E, an AND-OR gadget, with the weight of each node, is added. Recall that a is the global AND node introduced before and oₑ and aₑ are new OR and AND nodes corresponding to e respectively. Intuitively, using an edge e in the Steiner tree corresponds to killing the OR node oₑ in this gadget.

Next, it is shown that the cost of an optimum Steiner tree is equal to the minimum cost of nodes to be killed such that the remaining graph is deadlock-free. First, consider a Steiner tree S in G. All OR nodes corresponding to edges in S are killed. For each edge e=(u,v)∈S, killing Oₑ allows v to be complete after u. Thus, first complete node r, then complete nodes according to the directed Steiner tree. Since the Steiner tree solution contains a path to each terminal, all terminals can be completed. Now, after completing all terminals, the global AND node a can be completed and then every other node in the graph can be completed.

On the other hand, since the only nodes with finite weight are the OR nodes corresponding to edges and the node corresponding to root r, any feasible solution of finite weight for GDR kills only such nodes. It is easy to check that the set of edges for which the OR nodes are killed contain a directed Steiner tree. Again, each node of weight ∞ can be replaced with several nodes of unit weight, for example, |E(G)|, in order to reduce the directed Steiner tree problem to the uniform weighted case.

Natural LP and Hardness

Consider a natural LP for the GDR problem, which is a generalization of the LP for feedback vertex set (see, e.g., G. Even, J. Naor, B. Schieber, and M. Sudan, Approximating minimum feedback sets and multicuts in directed graphs, Algorithmica, 20 (1998), pp. 151-174). A set of nodes H forms a Minimal Deadlocked Structure (MDS) if:
1. For any OR node u∈H, all its out neighbors are in H.
2. For any AND node u∈H, at least one of its out neighbors is in H.
3. H is minimal (with respect to set inclusion) amongst sets satisfying (1) and (2).
A linear program (called LP 1) is now written as follows:

$$minimize {\sum }_{v ∈ V} {w}_{v} {x}_{v} such that {\sum }_{v ∈ H} {x}_{v} \geq 1 for any MDS H$$

$${x}_{v} \geq 0 ∀ v ∈ V$$

Clearly an integral solution to this linear program is a feasible solution to the underlying GDR instance and hence this is a relaxation. However, this linear program can potentially have exponentially many constraints. Note that if the graph G does not have any OR node, MDS's are exactly the minimal directed cycles and the LP is the same as the LP considered in other works (see, Leighton and Rao 1999; Seymour 1995; and Even, Naor, Schieber, and Sudan, 1998) for applying region growing techniques for the feedback vertex set problem. In this special case of feedback vertex set, this LP has a simple separation oracle which enables it to be solved using the Ellipsoid method. However, even the separation oracle for LP 1 is as hard as the directed Steiner tree problem.
Theorem 8: The separation oracle for LP 1 is as hard as solving the directed Steiner tree problem.
Proof: A separation oracle for LP 1 solves the following problem: given a vector x̅, is there an MDS H for which Σ_{v∈H}xᵥ<1. The directed Steiner tree problem is reduced to this problem

Consider an instance of directed Steiner tree: given a root r and a set of terminals T in a directed graph G=(V,E), is there a Steiner tree of weight at most 1 (by scaling). Without loss of generality, assume G is a directed acyclic graph (DAG), since the directed Steiner tree problem on DAGs is as hard as the one on general directed graphs (see, e.g. M. Charikar, C. Chekuri, T.Y. Cheung, Z. Dai, A. Goel, S. Guha, and M. Li, Approximation algorithms for directed Steiner problems, J. Algorithms, 33 (1999), pp. 73-91). Also, without loss of generality, assume there are weights on vertices instead of edges (again the two problems are equivalent). Now the reduction can be demonstrated. For each vertex v∈V, place an AND node v with xᵥ equal to its weight in the Steiner instance. For each edge (u,v) in G, place an edge (v,u) in the new graph. In addition, add an OR node with x_{O}=0 which has an outgoing edge (o,t) for each terminal t∈T and an incoming edge (r,o) (r is the root node). Call the new graph G′. It is easy to check that H∪{o} is an MDS in G′ if and only if H is a directed Steiner tree in G.

As shown by Jain, et al. (see, K. Jain, M. Mahdian, and M. R. Salavatipour, Packing steiner trees, in The Fourteenth Annual ACM-SIAM Symposium on Discrete Algorithms (SODA'03), 2003, pp. 266-274), for these kinds of problems optimizing LP 1 is equivalent to solving the separation oracle problem. Furthermore, these reductions are approximation preserving. Thus, if LP 1 can be optimized within some factor then its separation oracle can be solved for the same factor. Hence by Theorem 1, the directed Steiner tree problem can be solved within the same factor.
Corollary 9: Optimizing LP 1 is at least as hard as the directed Steiner tree problem.
   Few AND Nodes Algorithm

An O(nₐ log n)-approximation algorithm is provided for this problem, where nₐ is the number of AND nodes in the instance. Thus, when nₐ is small, the problem is well approximable. Note that in the reduction of set cover to generalized deadlock resolution (mentioned in Theorem 6), there is only one AND node and, thus, the result is tight in this case. However, in the reduction of directed Steiner tree to this problem, the number of AND nodes is linear and the best non-approximability result is in Ω(log² n).

The algorithm is as follows. Start with an original graph G and in each iteration it is updated. If in an iteration graph G does not have any AND node, the optimal solution for G can be obtained by the procedure mentioned in Proposition 2 (and, thus, the process halts at this point). Otherwise, for each AND node a whose outgoing edges are (a,c₁),(a,c₂), . . . , (a,c_{Δ}_{ₒᵤₜ}) in graph G and all cᵢ's, 1≦i≦Δₒᵤₜ, are OR nodes, the following hitting set instance (note that the hitting set problem is the dual of the set cover problem) is constructed. For each cᵢ, 1≦i≦Δₒᵤₜ, a set Sᵢ is formed which contains all OR nodes reachable via OR nodes from cᵢ (i.e. paths from Cᵢ to Sᵢ do not use any AND nodes). A collection C now contains all sets Sᵢ⊂S, where S is the set of all OR nodes. Using the (1+ln Δₒᵤₜ)=O(log n) approximation for the hitting set, a set S*ₐ of weight W*ₐ of OR nodes which hit every set is obtained. Let Wₐ=min{wₐ,w*ₐ}(wₐ is the weight of node a). Select the AND node a with minimum Wₐ over all AND nodes. Kill AND node a or all the OR nodes in the corresponding hitting set solution (the one with minimum weight). Clear graph G, i.e., remove every AND/OR node which can be completed after killing the aforementioned nodes, and repeat the above iteration for G. The final solution contains all AND/OR nodes killed during the iterations.

Thus,
Theorem 10: The above algorithm kills a set of AND/OR nodes such that the remaining graph is deadlock free and the weight of the solution is at most (1+lnΔₒᵤₜ)nₐ+1=O(nₐ log n) times optimum.
Proof: The correctness of the solution can be seen from the description of the algorithm. Thus, only the approximation factor is described here. To this end, it is shown that in each iteration, except the case in which there is no AND node, nodes of total weight at most (1+lnΔₒᵤₜ) times optimum weight for the updated graph G are killed in that iteration. In the last iteration, nodes of total weight at most OPT according to the description of the algorithm are killed.

Using these facts and that OPT in each iteration is at most the original optimum, the desired approximation factor is obtained.

Consider an optimum solution and let a be the first AND node which is completed or killed in the optimum resolution. Thus, either a is killed or a is completed by killing at least one OR node from the OR nodes reachable from each of its children. Hence, for at least one AND node, the weight of the solution to the corresponding hitting set instance is at most the weight of optimum. Since the approximation factor of hitting set is 1+lnΔₒᵤₜ and all AND nodes are tried and then the minimum is taken, the total weight of the killed nodes is at most (1+lnΔₒᵤₜ) times optimum, as desired.

Permanent Deadlock Resolution

Here, consider another version of the deadlock resolution problem where it is impossible for the algorithm to specify a feasible schedule on the remaining processes. In particular, it is desirable to kill enough processes, such that if the remaining processes try to acquire locks in any order, they cannot deadlock. Thus, the remaining processes are adversarially schedulable. Consider the special case of this problem when all processes are writers (AND nodes). In this case, it is shown that this problem can be reduced to the feedback vertex set problem on mixed graphs (i.e. graphs with both directed and undirected edges). Since this problem yields to the same techniques as those used for feedback vertex set of directed graphs, an O(log n loglog n)-approximation can be obtained.

Given a set of resources R and a set of processes P, each holding a lock on some subset of resources, and waiting to get locks on another subset of resources. Construct a bipartite mixed graph as follows: create a vertex vᵣ for every resource r with infinite cost, and a vertex vₚ for every process p. Whenever process p holds the lock on resource r, add a directed edge from vₚ to vᵣ. Moreover, add an undirected edge between vₚ and v_{r′} whenever process p is waiting to get a lock on resource r′.
Theorem 11: An instance is adversarially schedulable if and only if the corresponding graph is acyclic.
Proof: First, it is argued that greedily schedulability implies acyclicity.

Assume the contrary, and let the graph have a cycle p₁,r₁,p₂,r₂, . . . , pₖ,rₖ,p₁.

Now consider the schedule in which pᵢ grabs a lock on rᵢ (or already holds it, in case the edge is directed). Note that pᵢ waits for a lock on rᵢ₋₁ and P₁ waits on rₖ. This entails acyclic dependency amongst processes p₁, . . . , pₖ: pᵢ cannot finish unless pᵢ₋₁ finishes and releases rᵢ₋₁. This configuration is therefore deadlocked. Since it has been shown how to reach a deadlocked state from the initial state, the initial state was not adversarially schedulable, which contradicts the assumption.

Now suppose that the graph is acyclic. It is claimed that the initial configuration is adversarially schedulable. Suppose not. Then there is a sequence of lock acquisition that leads to a deadlocked configuration. Clearly, a deadlocked configuration corresponds to processes p₁,p₂, . . . ,pₖ such that pᵢ₊₁ is waiting for pᵢ to release some resource rᵢ. Since pᵢ holds rᵢ in this configuration, (pᵢ,rᵢ) must be directed/undirected edge in the graph. Moreover, since pᵢ₊₁is waiting for rᵢ, (rᵢ,pᵢ₊₁) is an undirected edge in the graph. However, it was just shown that p₁,r₁,p₂,r₂, . . . , pₖ,rₖ,p₁ is a cycle in G , which contradicts the acyclicity of G.
Theorem 12: The permanent deadlock resolution problem for AND nodes has an O(log n loglog n) approximation algorithm.
   Flow-based LP

Consider a flow-based LP and some natural variants for the GDR problem. According to Corollary 9, solving the LP 1 is equivalent, in terms of approximation factor, to the directed Steiner tree problem. In general, the flow LP can be of size exponential in the number of OR nodes. In the case where the number of OR nodes is constant, it is of polynomial size. For convenience, the flow LP is described only for the case when there is only one OR node and that too with infinite weight.

Since the weight of this OR node is infinite, this OR node cannot be removed. Further, since this OR node is involved in all the minimal deadlock structures, once this node is scheduled everything else could also be scheduled. To check whether this OR node is scheduled, this node is given an initial total flow of one unit. Any AND node which is picked to be killed has a potential of sinking 1 unit of flow. In case an AND node is picked fractionally to an extent f, then it can sink up to f units of flow. Suppose, a₁,a₂, . . . , aₖ, are the immediate children of the OR node. This OR node sends flows of f₁,f₂, . . . , fₖ towards these AND nodes. These flows are considered flows of different commodities. Intuitively, these flow track the cause of getting the OR node scheduled. In an integral solution, one of the flows should be one. But fractionally, the sum of the flows is one, i. e., f₁+f₂+. . . +fₖ=1.

These flows of different commodities are routed independently of each other except for the fact that if an AND node is picked to the extent of f then it can sink a total flow of at most f . Besides these aggregate constraints, these flows are independent and satisfy the following rules at every AND node. The total flow of a commodity received at an AND node is the maximum flow received of that commodity at an incoming edge. The AND node can sink some flow of this commodity subject to the aggregate constraint mentioned above. The remaining flow is copied to all the outgoing edges (and not conserved). If all the flow is sinked, i.e., no flow circulates back to the OR node, a feasible solution exists (in the general case, also an OR node can sink some flow of the commodities and the remaining flow is distributed among the outgoing edges with flow conversation).

Undirected Case: Generalizations of Vertex Cover and Feedback Vertex Set

The first undirected version of the problem is as follows. Given an undirected graph G, in which each vertex is either an AND node or an OR node, the goal is to remove a set of vertices of minimum weight such that all nodes of the remaining graph can be executed. Here all neighbors of an AND node and at least one neighbor of an OR node can be killed or executed in order to execute that node. One can easily observe that if all nodes are OR nodes, a node of minimum weight can be killed from each connected component. If all nodes are AND nodes, then at least one endpoint of each edge can be killed, which is the vertex-cover problem. For the case in which there are both AND nodes and OR nodes, it can shown that the problem is equivalent to dominating set and set cover and, thus, there is approximability Θ(log n) for this problem.

The second undirected version is very similar to the first one. The only difference is for an AND node, which can also be executed if all but one of its neighbors are killed or executed. Hence the problem with all OR nodes can be solved as mentioned before. Interestingly, the problem with all AND nodes is exactly the undirected feedback vertex set problem (since the minimal subgraphs having deadlock are cycles). However, set cover and directed Steiner tree problems can still be reduced to this variant of the GDR problem and, thus, in approximability Ω(log² n) exists for this problem. It is worth mentioning that when reducing the set cover problem to this variant, the number of AND nodes and OR nodes are linear, in contrast to the directed variant in which a linear number of OR nodes existed but only one AND node existed.

Again, the problem can be exactly solved for undirected uniform weighted graphs in which the number of AND nodes is in O(log n). If nₐ AND nodes exist in the graph, one can show that the minimum size of a deadlock subgraph is in O(nₐ). Then using the primal-dual algorithm of Bar-Yehuda et al. (see, R. Bar-Yehuda, D. Geiger, J. Naor, and R. M. Roth, Approximation algorithms for the feedback vertex set problem with applications to constraint satisfaction and Bayesian inference, SIAM J. Comput., 27 (1998), pp. 942-959 (electronic)), an O(nₐ) approximation algorithm can be obtained for the problem (in contrast to O(nₐ log n) approximation algorithm for the directed version).

Additional Variations

Another problem is whether a polylogarithmic or even an O(n^{ε}) approximation algorithm can be obtained for the GDR problem. Since an approximation preserving reduction from the directed Steiner tree problem to the GDR problem has been shown, any polylogarithmic approximation algorithm for the latter gives a polylogarithmic approximation algorithm for the former. When a small number of OR nodes exists, it is likely that such a polylogarithmic approximation algorithm for GDR can utilize some generalization of the “region-growing” technique of Leighton and Rao (see, Leighton and Rao 1999). More precisely, the current region growing technique uses some kind of BFS algorithm for each node. In the generalized version, it still can use BFS algorithm for AND nodes. However, some kind of DFS algorithm is needed for OR nodes. Another direction is extending the O(n^{ε}) approximation algorithm for directed Steiner tree due to Charikar et al. (see, Charikar, Chekuri, Cheung, Dai, Goel, Guha, and Li 1999) to the one for the GDR problem.

One step in determining the generalized nature of the GDR problem reducing the other hard covering problems such as the directed multicut problem (see, J. Cheriyan, H. J. Karloff, and Y. Rabani, Approximating directed multicuts, in The 42nd Annual Symposium on Foundations of Computer Science, 2001, pp. 348-356) or the generalized directed Steiner tree problem (see, Charikar, Chekuri, Cheung, Dai, Goel, Guha, and Li 1999) to the GDR problem. Such reductions can make obtaining polylogarithmic approximation algorithm for the GDR problem much more challenging.

Obtaining better approximation algorithms for the GDR problem on special graphs like planar graphs can be instructive as well. In fact, using the Separator theorem of Lipton and Taiwan (see, R. J. Lipton and R. E. Tarjan, Applications of a planar separator theorem, SIAM J. Comput., 9 (1980), pp. 615-627), it can be shown that the directed uniform weighted planar case has an approximation algorithm with factor O(\sqrt{n}). A solution to the open problem posed by Even et al. (see, Even, Naor, Schieber, and Sudan 1998), which asks whether there is an approximation algorithm with ratio better than O(log n loglog n) for the directed feedback vertex set, is likely to directly improve the algorithms provided herein.

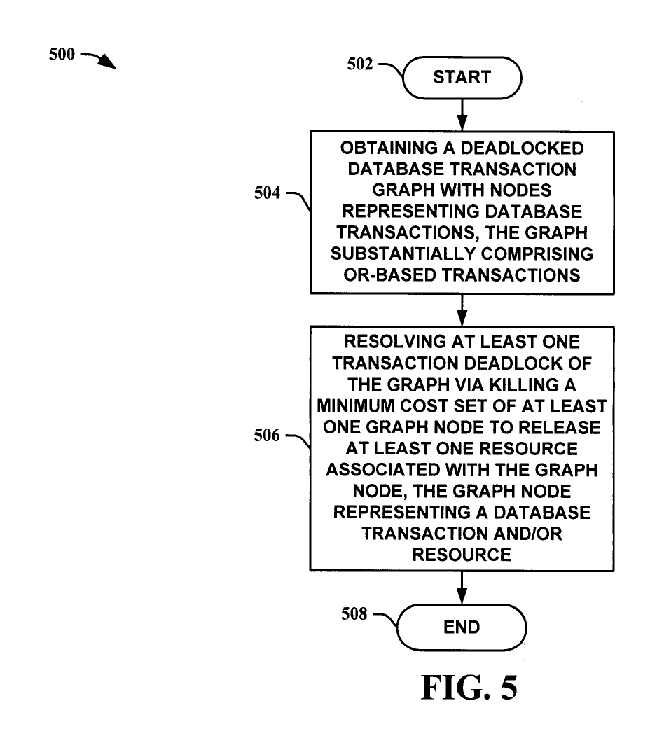

In view of the exemplary systems shown and described above, methodologies that may be implemented in accordance with the embodiments will be better appreciated with reference to the flow charts of FIGS. 5-7. While, for purposes of simplicity of explanation, the methodologies are shown and described as a series of blocks, it is to be understood and appreciated that the embodiments are not limited by the order of the blocks, as some blocks may, in accordance with an embodiment, occur in different orders and/or concurrently with other blocks from that shown and described herein. Moreover, not all illustrated blocks may be required to implement the methodologies in accordance with the embodiments.

The embodiments may be described in the general context of computer-executable instructions, such as program modules, executed by one or more components. Generally, program modules include routines, programs, objects, data structures, etc., that perform particular tasks or implement particular abstract data types. Typically, the functionality of the program modules may be combined or distributed as desired in various instances of the embodiments.

In FIG. 5, a flow diagram of a method 500 of facilitating deadlock resolutions in accordance with an aspect of an embodiment is shown. The method 500 starts 502 by obtaining a deadlocked database transaction graph with nodes representing database transactions, the graph substantially comprising OR-based transactions 504. At least one transaction deadlock of the graph is then resolved via killing a minimum cost set of at least one graph node to release at least one resource associated with the graph node, the graph node representing a database transaction and/or resource 506, ending the flow 508.

In one instance this can be accomplished by taking the deadlocked database transaction graph, G, and cyclically updating it. If in an iteration graph G does not have any AND nodes, the optimal solution for G can be solved in polynomial time. Otherwise, for each AND node a whose outgoing edges are (a,c₁),(a,c₂), . . . , (a,c_{Δ}_{ₒᵤₜ}) in graph G and all cᵢ's, 1≦i≦Δₒᵤₜ, are OR nodes, a hitting set instance can be constructed. Thus, for each cᵢ, 1≦i≦Δₒᵤₜ, a set Sᵢ can be formed which contains all OR nodes reachable via OR nodes from cᵢ. Now, a collection C contains all sets Sᵢ⊂S where S is a set of all OR nodes. Using the (1+lnΔₒᵤₜ)=O(log n) approximation for the hitting set instance, a set S*ₐ of weight w*ₐ of OR nodes which hit every set is obtained. Let Wₐ=min{wₐ,w*ₐ}(wₐ is the weight of node a). Select the AND node a with minimum Wₐ over all AND nodes and kill the AND node a or all the OR nodes in the corresponding hitting set solution (the one with minimum weight). Clear graph G, i.e., remove every AND/OR node which can be completed after killing the aforementioned nodes, and repeat the above iteration for G. The final solution contains all AND/OR nodes killed during the iterations.

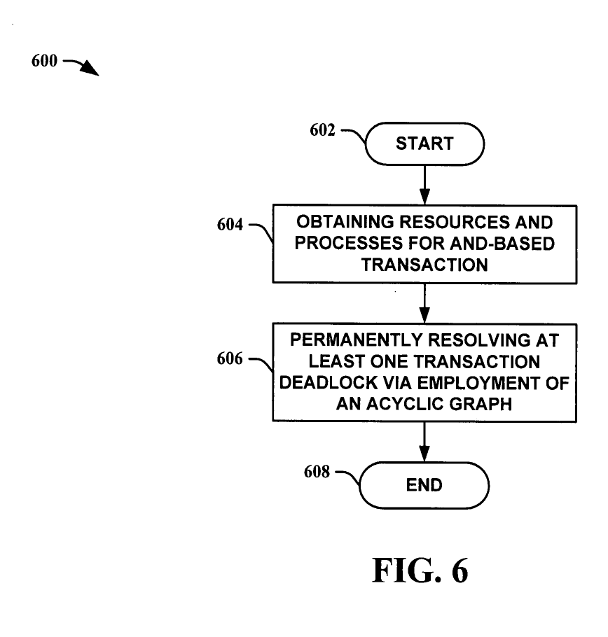

Turning to FIG. 6, a flow diagram of a method 600 of facilitating permanent deadlock resolutions in accordance with an aspect of an embodiment is depicted. The method 600 starts 602 by obtaining resources and processes for AND-based transactions 604. At least one transaction deadlock is then permanently resolved via employment of an acyclic graph 606, ending the flow 608. This can be employed where it is not possible for an algorithm to specify a feasible schedule on remaining processes. It is desirable to kill enough processes such that if the remaining processes try to acquire locks in any order, they cannot deadlock and, thus, are adversarially schedulable. When all processes are AND nodes, this problem can be reduced to the feedback vertex set problem on mixed graphs (i.e. graphs with both directed and undirected edges). Since this problem yields to the same techniques as those used for feedback vertex set of directed graphs, an O(log n loglog n)-approximation is obtained.

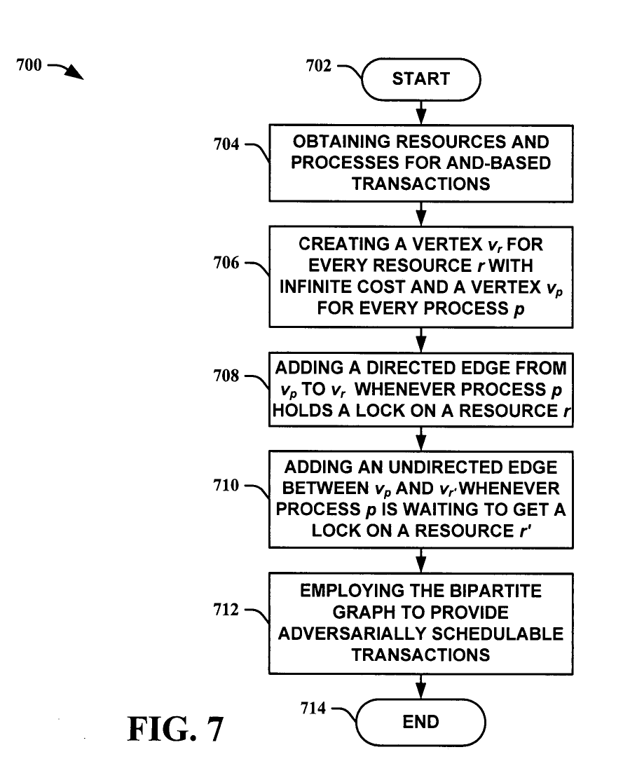

Looking at FIG. 7, another flow diagram of a method 700 of facilitating permanent deadlock resolutions in accordance with an aspect of an embodiment is illustrated. The method 700 starts 702 by obtaining resources and processes for AND-based transactions 704. The set of resources R and processes P can each hold a lock on a subset of resources and also can be waiting to get locks on other subsets of resources. Thus, a bipartite mixed graph is then constructed. A vertex vᵣ for every resource r with infinite cost and a vertex vₚ for every process p are then created 706. A directed edge from vₚ to vᵣ whenever process p holds a lock on a resource r is added 708. An undirected edge between vₚ and v_{r′} whenever process p is waiting to get a lock on a resource r′ is then added 710. The bipartite graph is then employed to provide adversarially schedulable transactions 712, ending the flow 714. This provides a permanent means of avoiding deadlocks.

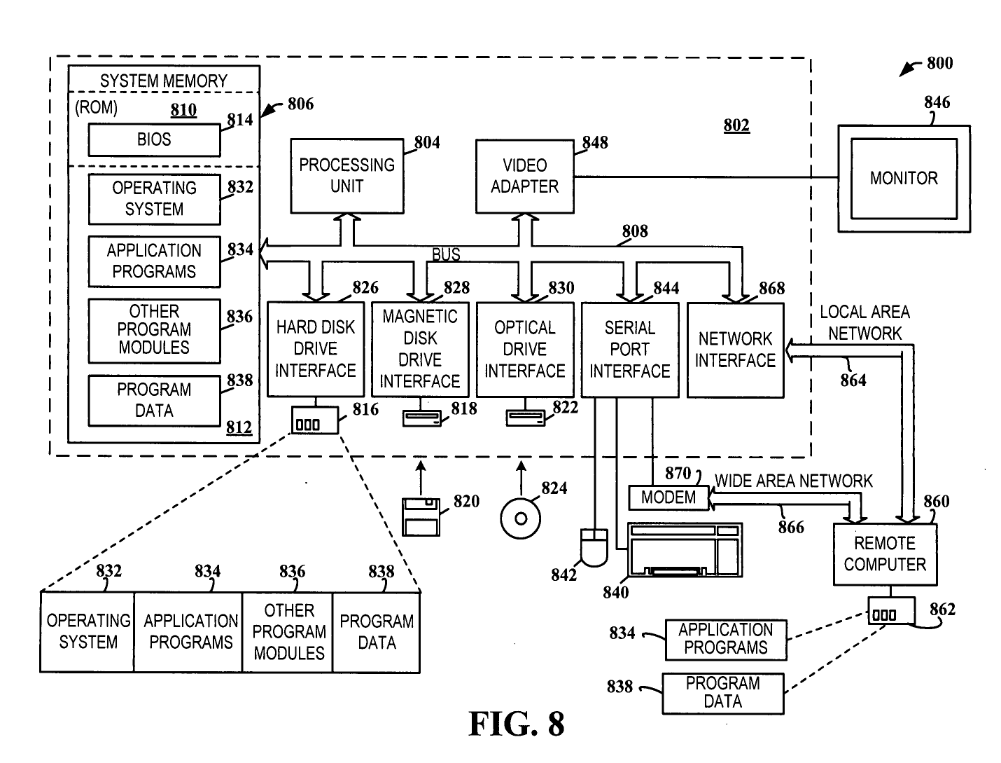

In order to provide additional context for implementing various aspects of the embodiments, FIG. 8 and the following discussion is intended to provide a brief, general description of a suitable computing environment 800 in which the various aspects of the embodiments can be performed. While the embodiments have been described above in the general context of computer-executable instructions of a computer program that runs on a local computer and/or remote computer, those skilled in the art will recognize that the embodiments can also be performed in combination with other program modules. Generally, program modules include routines, programs, components, data structures, etc., that perform particular tasks and/or implement particular abstract data types. Moreover, those skilled in the art will appreciate that the inventive methods can be practiced with other computer system configurations, including single-processor or multi-processor computer systems, minicomputers, mainframe computers, as well as personal computers, hand-held computing devices, microprocessor-based and/or programmable consumer electronics, and the like, each of which can operatively communicate with one or more associated devices. The illustrated aspects of the embodiments can also be practiced in distributed computing environments where certain tasks are performed by remote processing devices that are linked through a communications network. However, some, if not all, aspects of the embodiments can be practiced on stand-alone computers. In a distributed computing environment, program modules can be located in local and/or remote memory storage devices.

As used in this application, the term “component” is intended to refer to a computer-related entity, either hardware, a combination of hardware and software, software, or software in execution. For example, a component can be, but is not limited to, a process running on a processor, a processor, an object, an executable, a thread of execution, a program, and a computer. By way of illustration, an application running on a server and/or the server can be a component. In addition, a component can include one or more subcomponents.

With reference to FIG. 8, an exemplary system environment 800 for performing the various aspects of the embodiments include a conventional computer 802, including a processing unit 804, a system memory 806, and a system bus 808 that couples various system components, including the system memory, to the processing unit 804. The processing unit 804 can be any commercially available or proprietary processor. In addition, the processing unit can be implemented as multi-processor formed of more than one processor, such as can be connected in parallel.

The system bus 808 can be any of several types of bus structure including a memory bus or memory controller, a peripheral bus, and a local bus using any of a variety of conventional bus architectures such as PCI, VESA, Microchannel, ISA, and EISA, to name a few. The system memory 806 includes read only memory (ROM) 810 and random access memory (RAM) 812. A basic input/output system (BIOS) 814, containing the basic routines that help to transfer information between elements within the computer 802, such as during start-up, is stored in ROM 810.

The computer 802 also can include, for example, a hard disk drive 816, a magnetic disk drive 818, e.g., to read from or write to a removable disk 820, and an optical disk drive 822, e.g., for reading from or writing to a CD-ROM disk 824 or other optical media. The hard disk drive 816, magnetic disk drive 818, and optical disk drive 822 are connected to the system bus 808 by a hard disk drive interface 826, a magnetic disk drive interface 828, and an optical drive interface 830, respectively. The drives 816-822 and their associated computer-readable media provide nonvolatile storage of data, data structures, computer-executable instructions, etc. for the computer 802. Although the description of computer-readable media above refers to a hard disk, a removable magnetic disk and a CD, it should be appreciated by those skilled in the art that other types of media which are readable by a computer, such as magnetic cassettes, flash memory, digital video disks, Bernoulli cartridges, and the like, can also be used in the exemplary operating environment 800, and further that any such media can contain computer-executable instructions for performing the methods of the embodiments.

A number of program modules can be stored in the drives 816-822 and RAM 812, including an operating system 832, one or more application programs 834, other program modules 836, and program data 838. The operating system 832 can be any suitable operating system or combination of operating systems. By way of example, the application programs 834 and program modules 836 can include a database transaction facilitating scheme in accordance with an aspect of an embodiment.

A user can enter commands and information into the computer 802 through one or more user input devices, such as a keyboard 840 and a pointing device (e.g., a mouse 842). Other input devices (not shown) can include a microphone, a joystick, a game pad, a satellite dish, a wireless remote, a scanner, or the like. These and other input devices are often connected to the processing unit 804 through a serial port interface 844 that is coupled to the system bus 808, but can be connected by other interfaces, such as a parallel port, a game port or a universal serial bus (USB). A monitor 846 or other type of display device is also connected to the system bus 808 via an interface, such as a video adapter 848. In addition to the monitor 846, the computer 802 can include other peripheral output devices (not shown), such as speakers, printers, etc.

It is to be appreciated that the computer 802 can operate in a networked environment using logical connections to one or more remote computers 860. The remote computer 860 can be a workstation, a server computer, a router, a peer device or other common network node, and typically includes many or all of the elements described relative to the computer 802, although for purposes of brevity, only a memory storage device 862 is illustrated in FIG. 8. The logical connections depicted in FIG. 8 can include a local area network (LAN) 864 and a wide area network (WAN) 866. Such networking environments are commonplace in offices, enterprise-wide computer networks, intranets and the Internet.

When used in a LAN networking environment, for example, the computer 802 is connected to the local network 864 through a network interface or adapter 868. When used in a WAN networking environment, the computer 802 typically includes a modem (e.g., telephone, DSL, cable, etc.) 870, or is connected to a communications server on the LAN, or has other means for establishing communications over the WAN 866, such as the Internet. The modem 870, which can be internal or external relative to the computer 802, is connected to the system bus 808 via the serial port interface 844. In a networked environment, program modules (including application programs 834) and/or program data 838 can be stored in the remote memory storage device 862. It will be appreciated that the network connections shown are exemplary and other means (e.g., wired or wireless) of establishing a communications link between the computers 802 and 860 can be used when carrying out an aspect of an embodiment.

In accordance with the practices of persons skilled in the art of computer programming, the embodiments have been described with reference to acts and symbolic representations of operations that are performed by a computer, such as the computer 802 or remote computer 860, unless otherwise indicated. Such acts and operations are sometimes referred to as being computer-executed. It will be appreciated that the acts and symbolically represented operations include the manipulation by the processing unit 804 of electrical signals representing data bits which causes a resulting transformation or reduction of the electrical signal representation, and the maintenance of data bits at memory locations in the memory system (including the system memory 806, hard drive 816, floppy disks 820, CD-ROM 824, and remote memory 862) to thereby reconfigure or otherwise alter the computer system's operation, as well as other processing of signals. The memory locations where such data bits are maintained are physical locations that have particular electrical, magnetic, or optical properties corresponding to the data bits.

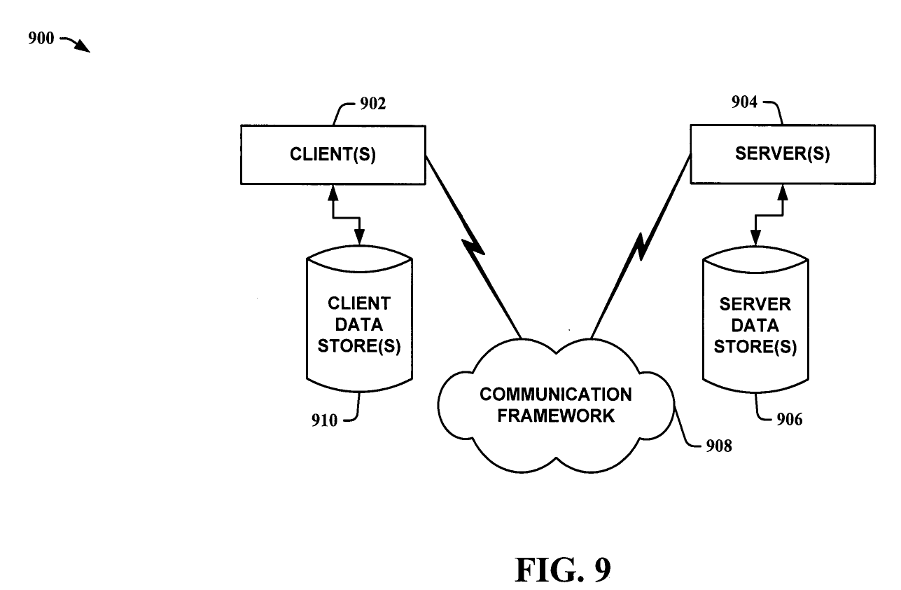

FIG. 9 is another block diagram of a sample computing environment 900 with which embodiments can interact. The system 900 further illustrates a system that includes one or more client(s) 902. The client(s) 902 can be hardware and/or software (e.g., threads, processes, computing devices). The system 900 also includes one or more server(s) 904. The server(s) 904 can also be hardware and/or software (e.g., threads, processes, computing devices). One possible communication between a client 902 and a server 904 can be in the form of a data packet adapted to be transmitted between two or more computer processes. The system 900 includes a communication framework 908 that can be employed to facilitate communications between the client(s) 902 and the server(s) 904. The client(s) 902 are connected to one or more client data store(s) 910 that can be employed to store information local to the client(s) 902. Similarly, the server(s) 904 are connected to one or more server data store(s) 906 that can be employed to store information local to the server(s) 904.

It is to be appreciated that the systems and/or methods of the embodiments can be utilized in database transaction facilitating computer components and non-computer related components alike. Further, those skilled in the art will recognize that the systems and/or methods of the embodiments are employable in a vast array of electronic related technologies, including, but not limited to, computers, servers and/or handheld electronic devices, and the like.

What has been described above includes examples of the embodiments. It is, of course, not possible to describe every conceivable combination of components or methodologies for purposes of describing the embodiments, but one of ordinary skill in the art may recognize that many further combinations and permutations of the embodiments are possible. Accordingly, the subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates database transactions comprising:
a receiving component that obtains a deadlocked database transaction graph with nodes representing database transactions, the graph substantially comprising OR-based transactions; and
a resolution component that resolves at least one transaction deadlock via killing a minimum cost set of at least one graph node to release at least one resource associated with the graph node, the graph node representing a database transaction and/or a database resource.

2. The system of claim 1, resolution component resolves at least one transaction deadlock in polynomial time when the deadlocked database transaction graph is comprised of solely OR-based transactions.

3. The system of claim 1, the resolution component resolves the deadlock with a cost of the minimum cost set limited to (1+lnΔₒᵤₜ)nₐ+1=O(nₐ log n) times optimum.

4. The system of claim 1, the resolution component determines a cost of a node via a weight assigned to the node.

5. The system of claim 1, the resolution component employs an iterative cycle of deadlock resolution comprising construction of a hitting instance set, weight determination for OR nodes which hit every set, and removal of an AND node with minimal weight and/or removal of OR nodes in a corresponding hitting set solution.

6. A database server employing the system of claim 1.

7. A method for facilitating database transactions, comprising:
obtaining a deadlocked database transaction graph with nodes representing database transactions, the graph substantially comprising OR-based transactions; and
resolving at least one transaction deadlock of the graph via killing a minimum cost set of at least one graph node to release at least one resource associated with the graph node, the graph node representing a database transaction and/or a database resource.

8. The method of claim 7 further comprising:
constructing a hitting instance set for each AND node a whose outgoing edges are (a,c₁),(a,c₂), . . . , (a,c_{Δ}_{ₒᵤₜ}) and cᵢ's, 1≦i≦Δₒᵤₜ that are OR nodes in the graph;
obtaining a set of weight of OR nodes of the graph which hit every set; and
killing AND node a with a minimum weight over AND nodes and/or OR nodes in the corresponding hitting set solution with a minimum weight.

9. The method of claim 8, the hitting instance set constructed by:
for each cᵢ, 1≦i≦Δₒᵤₜ:
forming a set Sᵢ which contains all OR nodes reachable via OR nodes from cᵢ such that a collection C contains all sets Sᵢ⊂S, where S is a set of all OR nodes.

10. The method of claim 8, the set of weights obtained by:
employing a (1+lnΔₒᵤₜ)=O(log n) approximation for the hitting instance set.

11. The method of claim 8 further comprising:
employing an iterative cycle of deadlock resolution.

12. A database server employing the method of claim 8.

13. A method for facilitating database transactions, comprising:
obtaining resources and processes for AND-based transactions; and
permanently resolving at least one transaction deadlock via employment of an acyclic graph.

14. A database transaction system that employs the method of claim 13 to provide adversarially schedulable transactions.

15. The method of claim 13 further comprising:
employing a bipartite mixed graph to facilitate in permanently resolving deadlock transactions.

16. The method of claim 15, the bipartite mixed graph constructed by:
creating a vertex vᵣ for every resource r with infinite cost and a vertex vₚ for every process p;
adding a directed edge from vₚ to vᵣ whenever process p holds a lock on a resource r; and
adding an undirected edge between vₚ and v_{r′} whenever process p is waiting to get a lock on a resource r′.

17. The method of claim 13 is performed with a guaranteed performance.

18. A database server employing the method of claim 13.

19. A device employing the method of claim 7 comprising a computer and/or a handheld electronic device.

20. A device employing the method of claim 13 comprising a computer and/or a handheld electronic device.
